(19) United States
(12) Patent Application Publication
(10) Pub. No.: US 2013/0159080 A1
(43) Pub. Date: Jun. 20, 2013

(54) System and Method for Mobile Device-Based Smart Wallet

(71) Applicants: Bo Wu, Beijing (CN); Yuhong Xiong, Beijing (CN)

(72) Inventors: Bo Wu, Beijing (CN); Yuhong Xiong, Beijing (CN)

(73) Assignee: LaShou Group Inc., Grand Cayman (KY)

(21) Appl. No.: 13/329,263

(22) Filed: Dec. 17, 2011

(51) Int. Cl. G06Q 30/02; G06Q 40/00

(52) U.S. Cl. 705/14.23; 705/26.41; 705/16; 705/14.25; 705/41

(57) ABSTRACT

A method for conducting a payment transaction using a smart wallet is proposed. The smart wallet accepts financial account information input by a consumer. The smart wallet stores the financial account information and transmits the financial account information to a smart wallet management server. When the consumer shops at a store, the smart wallet displays a list of merchandise purchased at the store and a total payment amount of the purchased merchandise. The smart wallet also provides a recommendation for making the payment amount. Finally, the smart wallet transmits a payment request to the smart wallet management server such that the payment is authorized and the payment transaction is completed. In one embodiment, the smart wallet can be used as a key to access shared mailboxes, resulting in significant improvement on package delivery operations for both couriers and consumers.

### TECHNICAL FIELD

The present invention relates generally to e-commerce and, more particularly, to method for mobile device-based smart wallet application.

### BACKGROUND

In a brick and mortar store environment, consumers have various ways to make a payment for the products or services they purchased. The payment can be made by credit card, debit card, membership card or cash. As a promotion mechanism, some stores also accept coupons to allow consumers to pay for certain products and services with a discounted price.

While different payment methods provide alternatives for consumers to pay for their commercial transactions, carrying and using many cards becomes a big burden for consumers. First, physical cards take space, so consumers can carry only a limited number of cards and coupons in their wallet or pocket. Also, when making a payment at a store, a consumer needs to decide which card to use depending on what cards are acceptable by the store and which card is the best financially in terms of rewards and interest rate for borrowing, etc. In addition, the consumer likes to use any valid coupons for the payment. Some merchants also require consumers to present certain identifications for validation purpose. Therefore, conducting a payment transaction at the store could be a time-consuming and error-prone process. Carrying physical card is also exposed to certain security risks, as cards can be lost or stolen.

Recently, several “electronic” technologies are introduced for providing better alternatives to physical cards and cash for payment transactions. Specially, the emerging of mobile device technology, such as tablet computers and smart phones, provides a general purpose computing and communication platform to run various software applications. To conduct a payment transaction, a mobile device communicates with a point of sale (POS) device installed at a merchant's store using various wireless and contactless technologies. For example, near field communication (NFC) enables simplified data exchange using wireless connection between two devices in proximity to each other. NFC is expected to become a widely used system for making payments by smart phone in the United States. Some smart phones currently on the market already contain embedded NFC chips that can send encrypted data across a short distance to a reader located next to a POS device, such as a cash register. Shoppers who have their credit card information stored in their NFC-enabled smart phones can pay for purchases by waving their smart phones near or tapping them on the POS device reader, rather than using the actual credit card. As a result, the application running on the mobile phone effectively becomes a “smart wallet”. For this reason, software application running on mobile devices for payment transactions is referred to as “smart wallet application”.

There are several ongoing efforts in the area of mobile phone-based smart wallet, such as U.S. patent applications “Payments Using a Mobile Commerce Device” (U.S. Ser. No. 11/830,459), “System and Method of Providing a Mobile Wallet At a Mobile Telephone” (U.S. Ser. No. 12/562,576), and “System and Method of Conducting Transactions Using Mobile Wallet System” (U.S. Ser. No. 12/562,593), each of which is expressly incorporated herein by reference in its entirety. Though smart wallets are already around, their reach isn't very vast because bringing NFC to all mobile phones and merchant's POSs are expensive. It is thus desirable to have a low-cost and easy-to-deploy smart wallet technology as an alternative to NFC technology. Furthermore, it is also desirable to provide additional value-added services to consumers via smart wallet application for various payment transactions.

### SUMMARY

A system and method for providing smart wallet application based on mobile phone devices is proposed. In one embodiment of the present invention, the smart wallet application on a consumer's mobile phone stores all financial accounts of the consumer in its database. As part of the checkout procedure at a merchant's store location, all the items purchased by the consumer are scanned into a POS device. A 2D barcode (e.g., a QR code) containing all purchased items is then generated. When the QR code is displayed on the POS device screen, the smart wallet application allows the consumer to take a photo of the QR code. The smart wallet also scans the QR code and lists all the items purchased with price information of each item as well as the total price. After the consumer selects one of the financial accounts for payment, the purchased payment information is transmitted to a smart wallet management server to initiate and authorize the payment transaction.

In another embodiment, the smart wallet application can recommend the best payment option(s) to the consumer to pay for the purchase. Information used by the smart wallet for such recommendation analysis includes the payment amount, any rewarding plan, the borrowing cost and payment installation, the account balance, and consumer's commercial activity history. Based on the analysis, the smart wallet recommends the best financial account(s) to the consumer to make the payment.

In yet another embodiment, a consumer can use the smart wallet to acquire coupons either from the smart wallet management server websites or from vendors' stores/websites. Coupons can be downloaded to the smart wallet or can be captured by simply taking the photo of the coupons. As the coupons acquired are stored in the smart wallet database, consumer can easily redeem them while shopping at the vendors' stores.

In one advantageous aspect, a smart wallet can be used as a key to access shared mailboxes. Instead of delivering packages to the physical residence of each consumer, a courier company can set up a number of mailboxes in a public place, such as a campus or a community center. Deliveries to all consumers living in the area are deposited to these mailboxes, and consumers can pick them up from these mailboxes. In one embodiment, a delivery person delivers a package to a mailbox and sends the mailbox number and a security code to a delivery tracking system. The delivery tracking system then sends a delivery notification to the consumer's smart wallet. Upon receiving the delivery notification, the consumer opens the mailbox using the security code.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a system using a mobile device-based smart wallet to conduct payment transactions in accordance with one novel aspect.

FIG. 2 illustrates information stored in the database of a smart wallet application and a smart wallet management server.

FIG. 3 is a message sequence chart that describes a detailed payment procedure using a mobile device-based smart wallet.

FIG. 4 illustrates one embodiment of a payment analysis process implemented in a smart wallet application for recommending the best payment options.

FIGS. 5A and 5B illustrate graphic user interfaces for a consumer to input financial institution accounts into a smart wallet application.

FIG. 6 illustrates a graphic user interface of a merchant's POS device for displaying a consumer's purchased merchandise.

FIG. 7A illustrates a graphic user interface on a mobile smart wallet application for displaying a captured two-dimensional barcode.

FIG. 7B illustrates a graphic user interface on a mobile smart wallet application for displaying purchased items and prices.

FIG. 7C illustrates a graphic user interface on a mobile smart wallet application to allow consumer to select a financial institution account for payment.

FIG. 8 illustrates one embodiment of a mobile device-based smart wallet that is used in a courier delivery system.

FIG. 9 is a message sequence diagram that describes the delivery process in which a smart wallet can be used as a key to open a mailbox.

FIGS. 10A and 10B illustrate graphic user interfaces on a mobile smart wallet to allow consumers to open a mailbox and retrieve a delivered package.

### DETAILED DESCRIPTION

Reference will now be made in detail to some embodiments of the invention, examples of which are illustrated in the accompanying drawings.

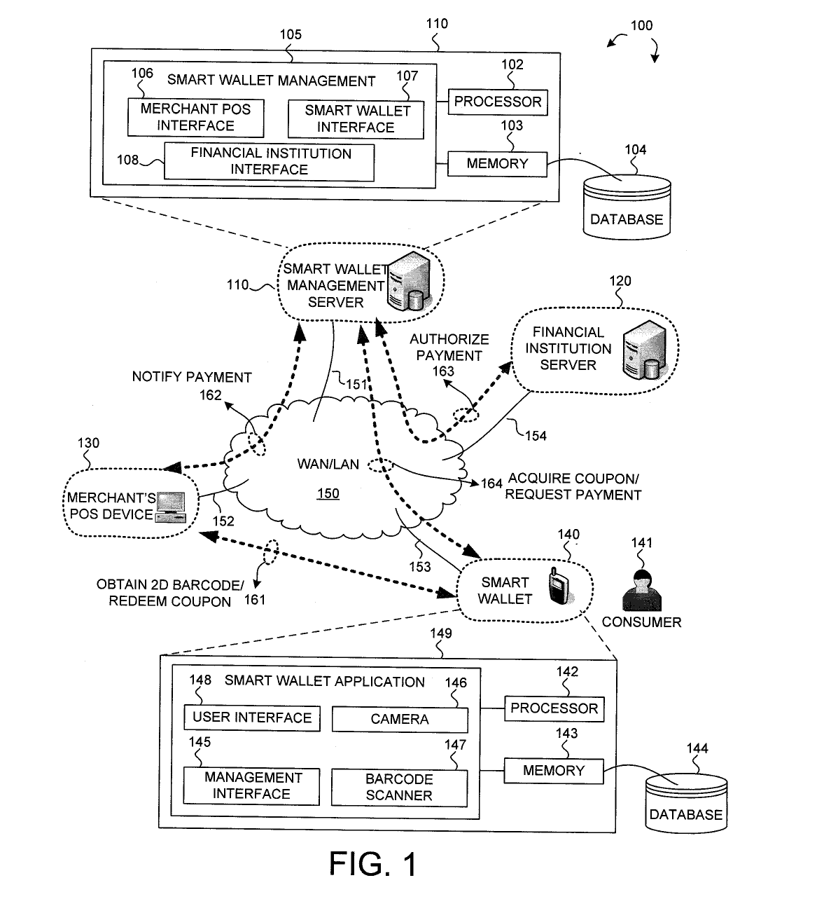

FIG. 1 illustrates a payment transaction system 100 in accordance with one novel aspect. Payment transaction system 100 comprises a smart wallet management server 110, a point-of-sale (POS) device 130 located at a merchant's mortar and brick store, a mobile device-based smart wallet 140 owned by a consumer 141, and a financial institution server 120. Smart wallet management server 110 comprises a processor 102, memory 103 coupled to a database 104 storing persistent data, and a smart wallet management module 105. Smart wallet management module 105 in turn comprises a POS interface 106, a smart wallet interface 107, and a financial institution interface 108 that enables communication with POS device 130, smart wallet 140, and financial institution server 120, respectively. The mobile device-based smart wallet 140 comprises a processor 142, memory 143 coupled to a permanent database 144, and a smart wallet application module 149. Smart wallet application module 149 in turn comprises a management interface 145 for communicating with smart wallet management server 110, a camera 146 for taking pictures, a barcode scanner 147 for scanning barcodes, and a user interface 148 for entering user information. Typically, the smart wallet and applications running on the smart wallet are referred to as “smart wallet application”.

In one embodiment, payment transactions are conducted by exchanging communication messages in payment transaction system 100 via WAN/LAN 150 (e.g., smart wallet management server 110, merchant's POS device 130, smart wallet 140, and financial institution server 120 are connected to WAN/LAN 150 via wired or wireless links 151, 152, 153, and 154 respectively). The different modules within smart wallet management server 110 are function modules that may be running on the same or different computer servers. The function modules, when executed by processor 102, allow consumer 141 to acquire coupon and to request payment via smart wallet management server 110. In one example, consumer 141 can download (take a photo of) a coupon using smart wallet 140 from smart wallet management server 110's website (e.g., depicted by a thick dashed-line 164). In another example, consumer 141 can request payment for the purchased product, and payment information is then authorized by financial institute server 120 (e.g., depicted by a thick dashed-line 163) and confirmed by merchant's POS device 130 (e.g., depicted by a thick dashed-line 162).

In one novel aspect, instead of relying on near field communication (NFC) technology, consumer 141 initiates payment transaction by taking a photo of a 2D barcode containing purchase information (e.g., depicted by a thick dashed-line 161). One example of a 2D barcode is a Quick Response (QR) code. Recently, QR codes have become popular in many industry and commercial areas due to its fast readability and comparatively large storage capacity. As compared to traditional 1D barcodes, QR codes can store (and digitally present) much more information including URL links, geographic coordinates, and text. Another key feature of QR codes is that instead of requiring a chunky hand-held scanner to scan them, many modern cell phones can scan QR codes. Moreover, QR codes can be easily generated using open source software utilities, and several websites provide QR code generation as well.

After smart wallet 140 scans the QR code, a list of purchased merchandise and prices is displayed on the mobile device. With consumer 141's confirmation, smart wallet 140 sends a message to smart wallet management server 110 to request payment from one of the financial accounts owned by consumer 141 (e.g., depicted by line 164). After receiving the payment request from smart wallet 140, smart wallet management server 110 authorizes the payment by sending a message to financial institution server 120 (e.g., depicted by line 163). When authorization is received from financial institution server 120, smart wallet management server 110 notifies merchant's POS device 130 that the payment transaction is completed (e.g., depicted by line 162). Store personnel then can release the merchandise to consumer 141. The purchase and payment transaction is saved by smart wallet management server computer 110 onto database 104.

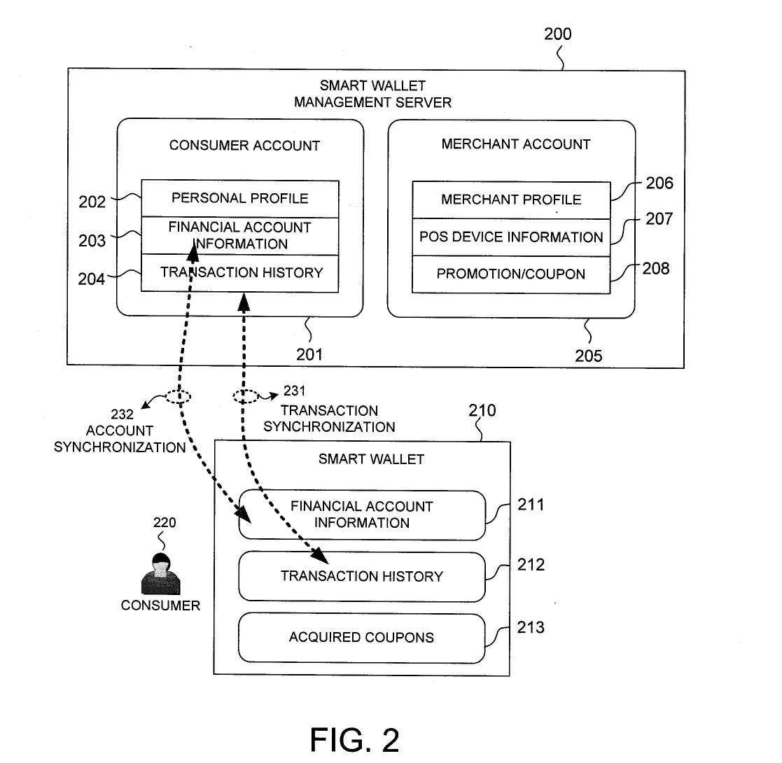

FIG. 2 shows information stored in a smart wallet management server 200 and a smart wallet 210. In order to manage all the smart wallets and coordinate various payment transactions, smart wallet management server 200 stores all necessary information in its database. The database comprises a consumer account table 201 and a merchant account table 205. Consumer account table 201 stores consumer account information for each consumer, including a personal profile entry 202, a financial account information entry 203, and a transaction history entry 204. Personal information related to each consumer—such as name, gender, residential address, email, and phone number—is stored in personal profile entry 202. Financial account information entry 203 keeps all financial accounts, such as credit card and debit card, which can be used to settle the payment by each consumer. Furthermore, smart wallet management system 200 also keeps track of each consumer's previous commercial activities in transaction history entry 203. The transaction history can be used for the smart wallet management system to provide value-added services, such as recommending the best payment choices and searching for coupons. Merchant account table 205 stores merchant account information for each merchant, including a merchant profile entry 206, a POS device information entry 207, and a promotion/coupon entry 208. Additional merchant information—such as name, address, type of business and contact information, etc.—is stored in merchant profile entry 206. Information stored in POS device information entry 207, such as POS registration info, is used to identify and authenticate merchant's POS devices during the payment transactions. Promotion/coupon entry 208 stores all the coupons issued by the merchants for consumers to search and retrieve.

FIG. 2 also shows information stored in the database of smart wallet 210 of consumer 220. The database comprises a financial account information entry 211, a transaction history entry 212, and a coupon entry 213. Financial account information entry 211 stores information of all the financial accounts owned by the consumer, such as the institution name, the account number, and the access password. Additional information related to financial accounts includes account balance, credit limit, reward policy, interest rate, and penalty. Through smart wallet user interface, consumer 220 can add a financial account into financial information entry 211. Note that financial account information entry 211 is synchronized with the financial account information entry 203 in consumer account table 201 of the smart wallet management server 200 database (e.g., depicted by a thick dashed-line 232). For example, when a financial account is added into entry 211 by consumer 220, the account information is also transmitted to smart wallet management server 200 and stored in entry 203 of consumer account table 201 for the consumer. All previous commercial transactions are kept in transaction history entry 212. Note that transaction history entry 212 is also synchronized with transaction history entry 204 in consumer account table 201 of the smart wallet management server 200 database (e.g., depicted by a thick dashed-line 231). For example, after a payment transaction is completed, smart wallet management server 200 transmits completed purchase transaction to smart wallet 210 which saves the transaction in transaction history entry 212. This synchronization between smart wallet 210 and smart wallet management server 200 is useful in case consumer 220 has lost or wants to replace smart wallet 210. In such event, the financial accounts and transaction history data stores in smart wallet management server 200 can be downloaded to the database of the smart wallet application running on the new mobile device. This effectively eliminates the need of re-entering all the lost data by consumer 220.

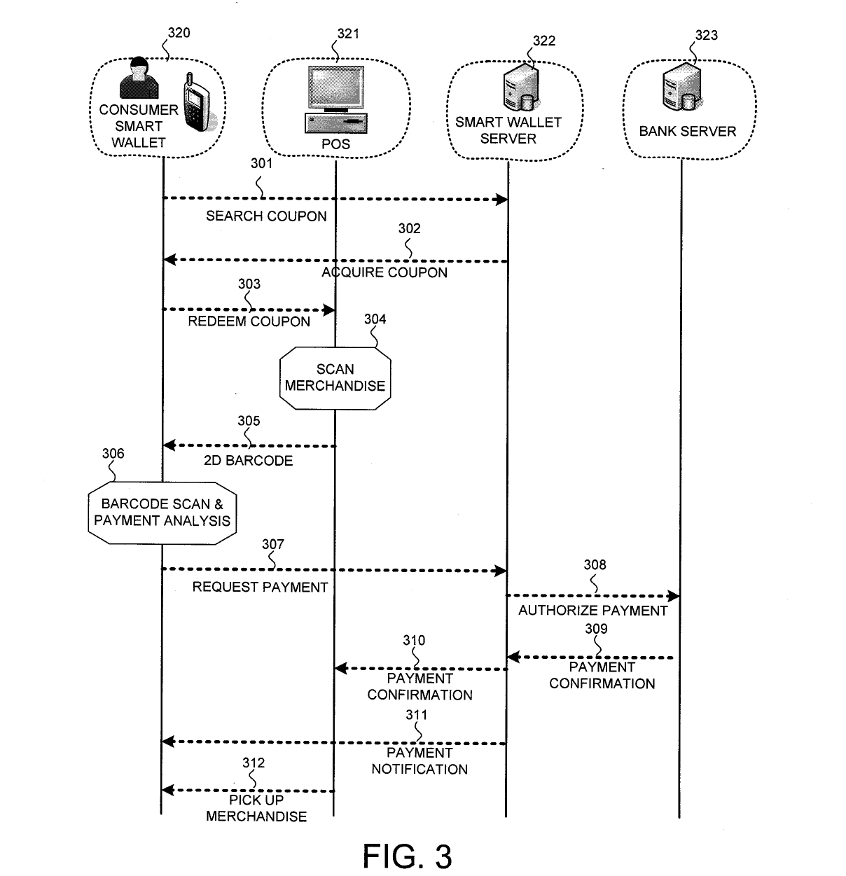

FIG. 3 is a message sequence chart for describing interactions among a smart wallet 320, a vendor's POS device 321, a smart wallet management server 322, and a financial institution server 323. In step 301, before the start of shopping, a consumer uses the user interface of smart wallet 320 to search coupons issued by vendors from the smart wallet management server 322 website. Smart wallet 320 acquires coupons by downloading the coupon image or code representing the coupon from smart wallet management server 322 in step 302. After finishing shopping at a store, the consumer proceeds to check out at vendor's POS device 321 and the coupons can be redeemed against the merchandise purchased in step 303. Once all the merchandise are scanned by POS device 321, a 2D barcode image together with a list of merchandise and prices are generated and displayed on the display screen of POS device 321 in step 304. The 2D barcode image is transferred to smart wallet 320 by taking a photo of the image in step 305. In step 306, the 2D barcode scanner of smart wallet 320 scans the 2D barcode image. Accordingly, the list of merchandise and corresponding prices are displayed on the display screen of smart wallet 320 for the consumer to verify. In addition, based on analysis of the total price and the consumer's transaction history, smart wallet 320 recommends one or more financial accounts to be used for making the payment. After reviewing the recommendation, the consumer selects one of the financial accounts and sends a payment request message to smart wallet management server 322 in step 307. The payment request message includes the purchase information, such as vendor name, POS device identifier, list of merchandise and prices, as well as the selected financial account for payment. In step 308, smart wallet management server 322 authorizes the payment by sending a message which includes the consumer's financial account number and credential, vendor's POS device identifier and the total price to financial institution server 323. After the payment is settled, in step 309, financial institution server 323 sends a confirmation message back to smart wallet management server 322, which relays the confirmation message to the vendor's POS device 321 in step 310. The smart wallet management server 322 also sends a notification message including the payment transaction record to smart wallet 320 in step 311. Finally, in step 312, the consumer picks up the purchased merchandise and leaves the store.

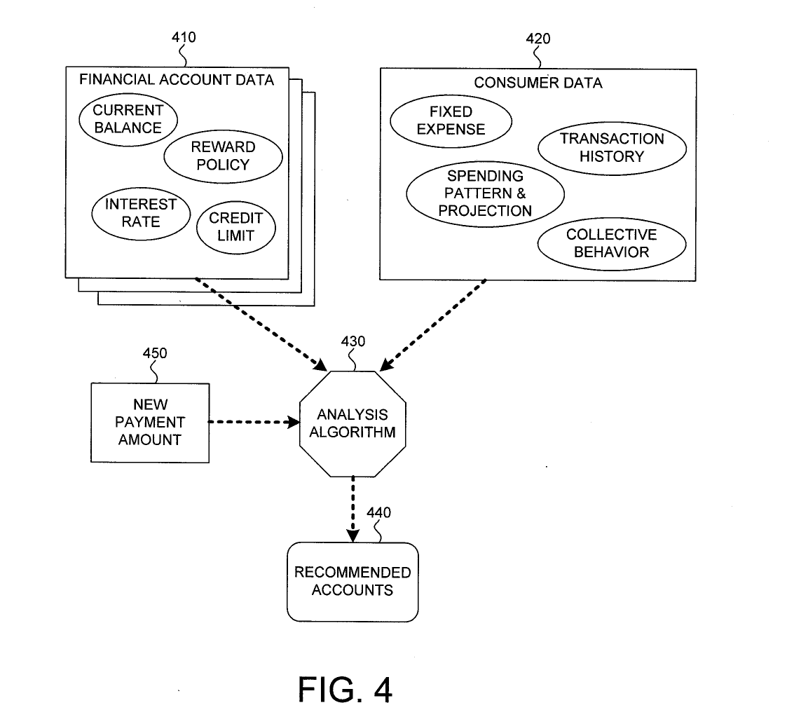

FIG. 4 shows one embodiment of a payment analysis process implemented in a smart wallet application for recommending the best account(s) for consumers to make a purchase payment. Payment analysis algorithm 430 uses both financial account data shown in block 410 and consumer data shown in block 420 for payment analysis. In block 410, for each financial account owned by a consumer, current balance, rewards policy, interest rate and credit limit are considered. The accounts with low interest and high rewards are desirable, provided that applying the new payment 450 will not exceed the credit limit. In addition, in block 420, the consumer's fixed monthly payments and previous commercial transactions can also be used to predict potential spending in the near future. For example, with a potential large purchase coming in the next few days, the account with the largest amount available should be reserved and not recommended. In addition, the collective behavior of other consumers may also be used for payment analysis. A typical example of such collaborative filtering analysis is “People who have bought this product have also enrolled in that reward program”. With those considerations, analysis algorithm 430 produces a list of recommended accounts 440 for consumer to review and choose. Note that since the smart management server also stores all the data needed for such analysis, the payment analysis can be implemented and performed by the smart wallet management server as well.

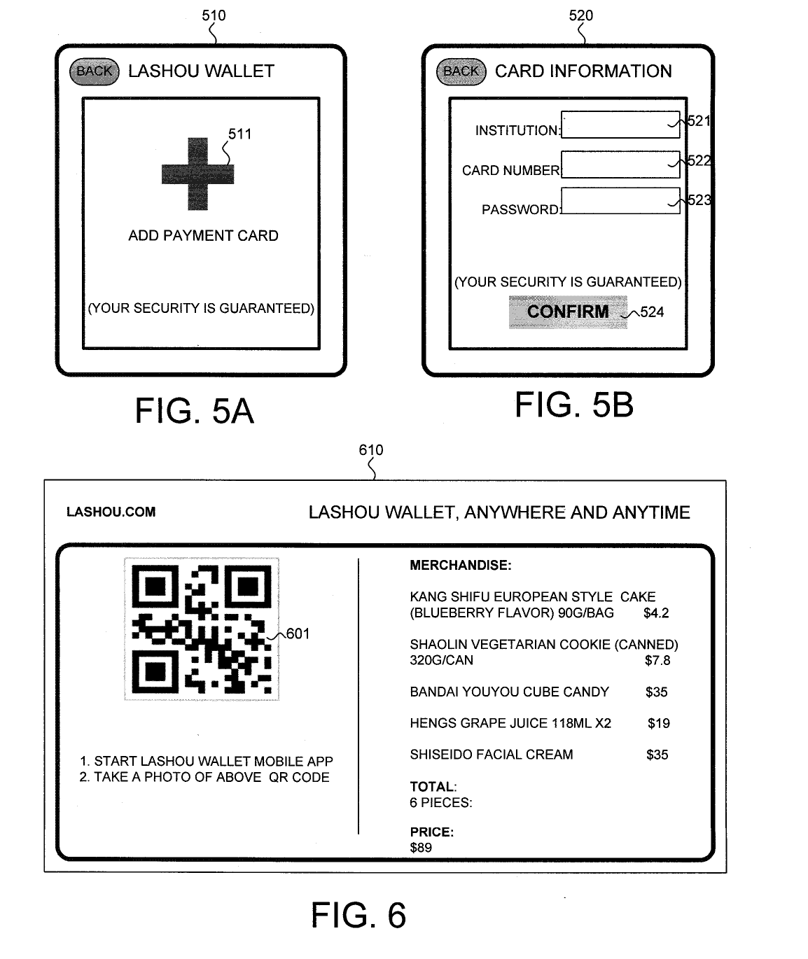

Reference will now be made to some graphic user interfaces (GUIs) of smart wallets and POS devices. FIGS. 5A and 5B illustrate the graphic user interfaces for a consumer to input financial institution accounts onto a smart wallet application. In the example of FIG. 5A, after starting the smart wallet application on the smart wallet, the consumer can click/tap cross symbol 511 in GUI 510 to add a new payment card. In the example of FIG. 5B, GUI 520 is used for the consumer to input the financial institution's name in field 521, the consumer's account number in field 522, and a password for accessing the account in field 523. When the confirm button 524 is clicked or tapped, the financial account information is saved in the smart wallet database and also transmitted to the smart wallet management server.

FIG. 6 illustrates a graphic user interface GUI 610 of a merchant's POS device for displaying the consumer's purchased merchandise. Referring back to step 304 in FIG. 3, merchandise purchased by the consumer are scanned by the POS device for generating a merchandise list as well as a 2D barcode image. The left side of GUI 610 displays the 2D barcode image 601, while the right side of GUI 610 displays the detail description and the prices of all the items purchased. The total number of items and the total price are also displayed. Referring back to steps 305-306 in FIG. 3, the 2D barcode image is transferred to a smart wallet of the consumer by taking a photo of the image. The 2D barcode image is then scanned by the smart wallet and the list of merchandise and corresponding prices are displayed on the display screen of the smart wallet for the consumer to verify.

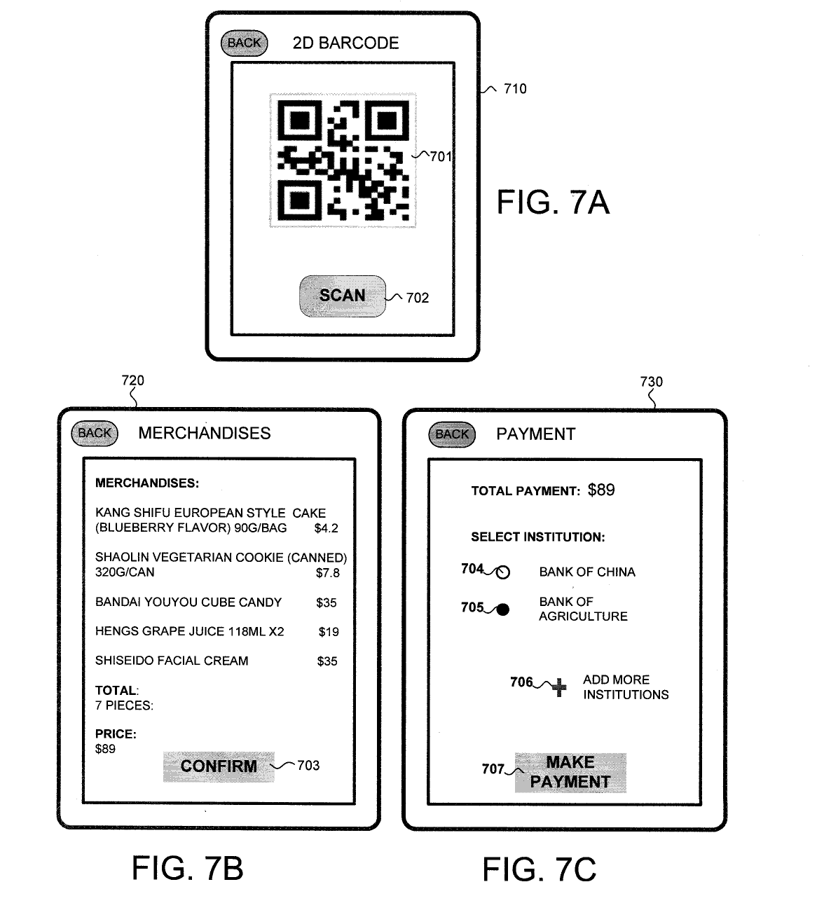

FIG. 7A illustrates a graphic user interface GUI 710 on a mobile smart wallet application for displaying a captured 2D barcode image. After the smart wallet takes a photo of the 2D barcode image 701, the consumer can decode the 2D barcode by clicking/tapping the scan button 702 in GUI 710. FIG. 7B illustrates a graphic user interface GUI 720 on a mobile smart wallet application for displaying purchased items and prices. After decoding the 2D barcode, the smart wallet displays the items purchased with descriptions and prices as shown in GUI 720 for consumer reviewing. After verifying, the consumer can proceed to payment procedure by clicking/tapping the confirm button 703 in GUI 720. The smart wallet application then recommends the best accounts for payment and displays all accounts available for payment with one recommended account as the default selection.

FIG. 7C illustrates a graphic user interface GUI 730 on a mobile smart wallet application to allow consumer to select a financial institution account for payment. In the example of FIG. 7C, there are two financial accounts—Bank of China (e.g., depicted by dot 704) and Bank of Agriculture (e.g., depicted by dot 705)—are stored in the smart wallet database and available for payment. These two accounts are displayed for the consumer to choose. Since the smart wallet recommends Bank of Agriculture for the payment, it shows Bank of Agriculture as the default selection, as shown by solid dot 705. The consumer can accept the recommendation and proceed with the payment or overwrite the recommendation by selecting another account for payment. The consumer confirms the payment selection by clicking/tapping make payment button 707 as shown in FIG. 7C. Note that the option of adding another financial account is also available in GUI 730 as shown by a cross symbol 706, in case the consumer wants to use additional accounts.

In one advantageous aspect, a smart wallet may be used to open a shared mailbox installed in a public location. In today's courier industry, all goods and products are delivered to the consumer's residence. Delivering to a large number of destinations is a time-consuming and high-cost operation for couriers. Such delivery sometimes requires the consumer's presence or signature during the delivery, especially for expensive items. Another way of delivering is for a courier company to install a number of “mailboxes” in its local branches or a public place, such as a community center or college campus. These mailboxes are like the ones in the US post offices, but instead of using a metal key, consumers can use the security code to open the boxes. This way, the consumer does not need to be present when a delivery person makes the delivery. The delivery person can just put the package into a mailbox and the consumer can pick up at his/her convenient time. One advantage of such mailboxes is that the mailboxes do not need to be pre-assigned to each consumer, and they are shared by everyone in the area. A smaller number of mailboxes thus can serve a much larger population of consumers within an area.

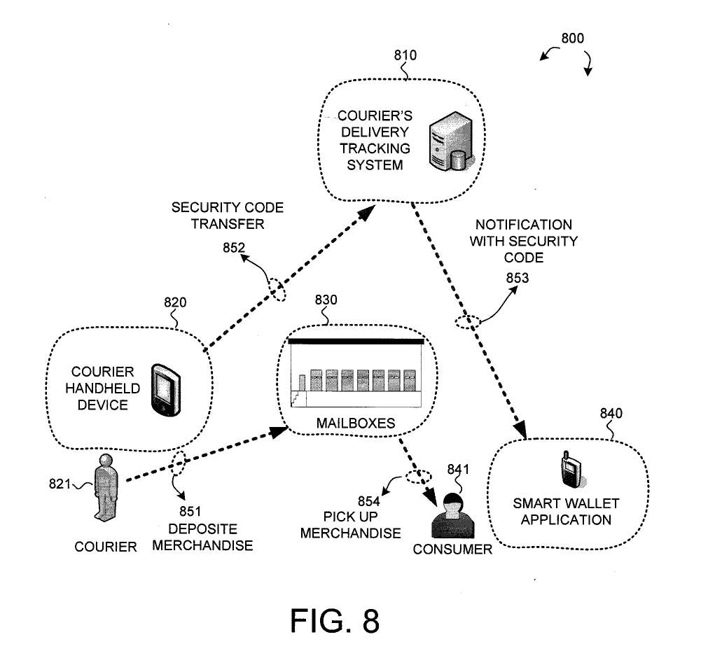

FIG. 8 illustrates a package delivery system 800 using smart wallet application as a key to open mailboxes. As shown in FIG. 8, a number of mailboxes 830 are installed in an area for packages to be delivered to consumers in that area. A courier personnel 821 deposits a package into an empty mailbox and locks the mailbox with a security code (e.g., depicted by a thick dashed-line 851). The courier personal 821 then transmits the mailbox number and its security code to the courier company's delivery tracking system 810 using a courier handheld device 820 (e.g., depicted by a thick dashed-line 852). Upon receiving the message including the mailbox number and the security code, courier delivery tracking system 810 sends the mailbox number and its security code to the consumer's mobile device-based smart wallet application 840 (e.g., depicted by a thick dashed-line 853). Consumer 841 then can go to the mailbox location and pick up the package using the security code stored in the smart wallet (e.g., depicted by a thick dashed-line 854). The emptied mailbox becomes available and can be used for the next delivery by the courier personnel.

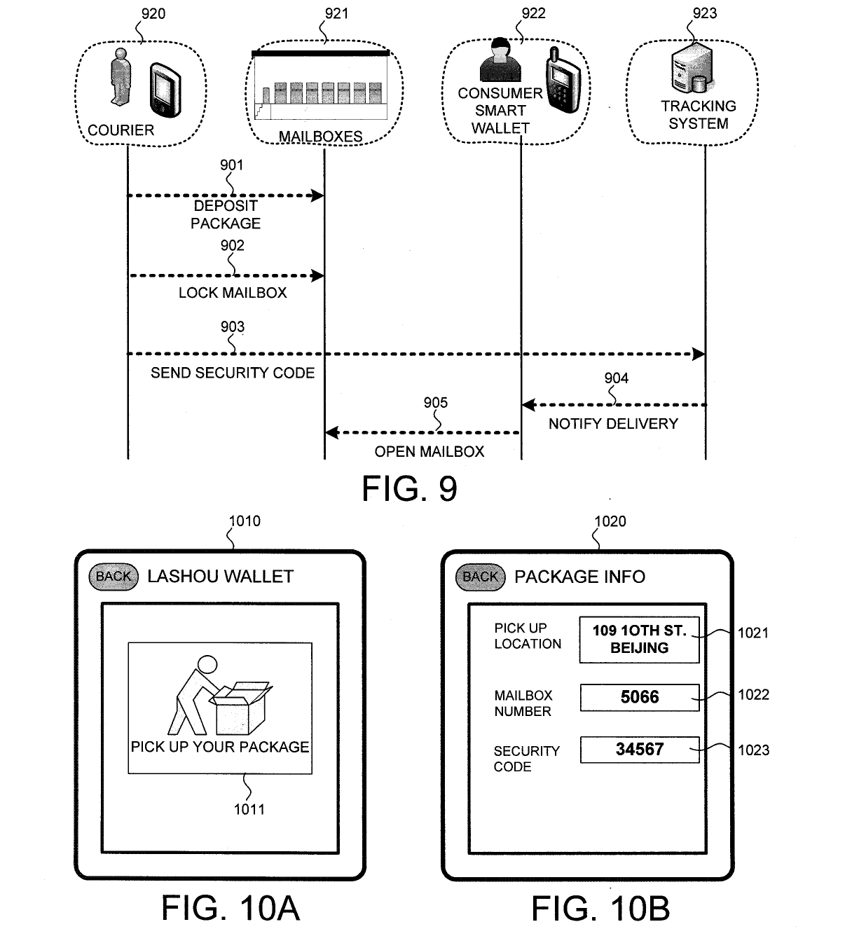

FIG. 9 is a message sequence diagram that describes a delivery process involving a smart wallet. At step 901, after identifying an empty mailbox from a number of mailboxes 921, courier personnel 920 deposits a package into the mailbox and locks the mailbox with a security code at step 902. If NFC is supported, the security code is programmed into the lock which can only be opened by an NFC signal containing the security code from a NFC device. Otherwise, the lock is set so that it can be opened by punching the security code on its keypad. At step 903, courier personnel 920 transmits the mailbox number as well as the assigned security code to the courier's delivery tracking system 923 using a courier handheld device. Upon receiving the message including the mailbox number and the security code, courier delivery tracking system 923 notifies consumer 922 by sending a message with the mailbox number, the security code, and the mailbox location to the consumer's smart wallet application at step 904. After receiving the notification message, the smart wallet application stores the mailbox number, the security code, and the mailbox location. The smart wallet application also notifies consumer 922 by displaying the mailbox location, the mailbox number, and the security code. Consumer 922 then goes to the mailbox location to pick up the package. If NFC is supported between the smart wallet and the mailbox equipment, consumer 922 can read the mailbox number from the smart wallet GUI and approach the mailbox to open it by waving or tapping the smart wallet against the NFC-based lock opener. In a more traditional way, consumer 922 reads both the mailbox number and the security code, and opens the mailbox by punching the security code onto the mailbox's keypad.

FIGS. 10A and 10B illustrate graphic user interfaces of a smart wallet for picking up delivered packages. After the smart wallet receives a message from a delivery tracking system, it displays a graphic notification 1011 as shown in FIG. 10A. The owner of the smart wallet can click/tap on icon 1011 to see the details about the delivery in GUI 1020 as shown in FIG. 10B, which includes a pickup location as shown in field 1021, a mailbox number as shown in field 1022, and a security code as shown in field 1023.

In one or more exemplary embodiments, the functions described above may be implemented in hardware, software, firmware, or any combination thereof. If implemented in software, the functions may be stored on or transmitted over as one or more instructions or code on a computer-readable (processor-readable) medium. Computer-readable media include both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that both can be used to carry or store desired program code in the form of instructions or data structures, and can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies are included in the definition of medium. Disk and disc, as used herein, include compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for conducting a payment transaction using a smart wallet, the method comprising:
accepting financial account information input by a consumer, wherein the financial account information includes a financial institution name, an account number and an access password;
storing the financial account information and transmitting the financial account information to a smart wallet management server;
obtaining and displaying a list of merchandise purchased at a store and a total payment amount for the purchased merchandise;
providing a recommendation for making the payment amount; and
transmitting a payment request to the smart wallet management server.

2. The method of claim 1, wherein the obtaining involves taking a photo of a barcode image that is generated from a point of sale (POS) device at the store and scanning the barcode image.

3. The method of claim 2, wherein the barcode image contains a two-dimensional Quick Response (QR) code.

4. The method of claim 1, wherein the recommendation involves analyzing the payment amount, the financial account information, and consumer transaction history information.

5. The method of claim 4, wherein the financial account information used for recommendation analysis further includes an account balance, a credit limit, an interest rate, and a rewards policy.

6. The method of claim 4, wherein the consumer transaction history information used for recommendation analysis includes fixed payments, previous purchase transactions, and spending patterns.

7. The method of claim 1, further comprising:
acquiring a coupon of a promotion product or service from a smart wallet management server website or from a merchant website; and
redeeming the coupon during purchasing the promotion product or service at the store.

8. The method of claim 1, further comprising:
storing the payment transaction and synchronizing the consumer transaction history information with the smart wallet management server.

9. A method for managing smart wallet applications, the method comprising:
storing and updating a plurality of smart wallet consumer accounts, wherein each consumer account comprises a personal profile, financial account information, and transaction history information;
receiving a payment request for a specific payment amount transmitted from a smart wallet application by a consumer; and
recommending a payment method to the consumer and authorizing a selected payment method.

10. The method of claim 9, wherein the recommending involves analyzing the specific payment amount with the financial account information and the transaction history information of the consumer.

11. The method of claim 10, wherein the financial account information used for recommendation analysis further includes an account balance, a credit limit, an interest rate, and a reward policy.

12. The method of claim 10, wherein the transaction history information used for recommendation analysis includes fixed payments, previous purchase transactions, and spending patterns.

13. The method of claim 9, further comprising:
storing and updating a plurality of merchant accounts, wherein each merchant account comprises a merchant profile, point of sale device information, and coupon information.

14. The method of claim 9, further comprising:
transmitting a coupon to the smart wallet application based on the personal profile and the transaction history information of the consumer.

15. The method of claim 9, further comprising:
receiving a coupon search request from the consumer; and
searching coupons from the coupon information based on the coupon search request.

16. The method of claim 9, wherein the authorizing involves forwarding the payment amount with the selected payment method and receiving a payment confirmation from a financial institution server.

17. A method of providing delivery via public mailboxes, the method comprising:
receiving delivery information transmitted from a mobile device of a delivery personnel; and
transmitting a delivery notification to a smart wallet application of a consumer based on the received delivery information, wherein the delivery notification comprises a mailbox address, a mailbox number, and a security code, and wherein the security code is used by the consumer to open a mailbox with the mailbox number located at the mailbox address.

18. The method of claim 17, wherein opening the mailbox involves transmitting the security code to the mailbox using near field communication technology.

19. The method of claim 17, wherein opening the mailbox involves inputting the security code onto a keypad of the mailbox.

20. The method of claim 17, wherein the mailbox is used for a first delivery to a first consumer, and wherein the same mailbox is used for a second delivery to a second consumer.
